(19) United States
(12) Patent Application Publication
(10) Pub. No.: US 2023/0033571 A1
(43) Pub. Date: Feb. 2, 2023

(54) BUSINESS DATA PROCESSING SYSTEM, METHOD, AND COMPUTER PROGRAM PRODUCT

(71) Applicant: SmartBee Intelligence Company Limited, Taipei City (TW)

(72) Inventors: JEN-WEN WANG, Taipei City (TW); Tzu-Wen WU, Taipei City (TW); Kuo-Lien WANG, Taipei City (TW)

(21) Appl. No.: 17/873,296

(22) Filed: Jul. 26, 2022

Related U.S. Application Data
(63) Continuation of application No. 63/226,777, filed on Jul. 29, 2021.

(51) Int. Cl. G06Q 40/02; G06F 16/25; G06V 30/42; G06F 40/194

(52) U.S. Cl. CPC G06Q 40/025; G06F 16/254; G06V 30/42; G06F 40/194

(57) ABSTRACT

A business data processing system performing communication with a user device and a finance end device is provided. The business data processing system includes a data organizing subsystem and a data evaluation subsystem. The data organizing subsystem receives documents of a cargo transport task provided by the user device, and recognizes and organizes the contents of the documents. The data evaluation subsystem analyzes the contents of the documents to generate an evaluation of the transport task. The business data processing system transmits the evaluation of the transport task to the finance end device.

### CROSS REFERENCE TO RELATED APPLICATION

This application claims the benefit of filing date of U.S. Provisional Application Ser. No. 63/226,777, entitled “FINANCIAL APPLICATION AND METHOD BASED ON LOGISTICS BIG DATA” filed Jul. 29, 2021 under 35 USC § 119(e)(1).

BACKGROUND

### 1. Field of the Disclosure

The present invention relates to the technical field of data processing and, more particularly, to a business data processing technology.

### 2. Description of Related Art

With globalization, the number of business activities is significantly increased, which may cause a large amount of business data to be generated. Logistics operators usually need to make various prepayments for customers and thus require large sums of money, so that the logistics company must borrow money from financial service ends. Usually, the company must provide a large amount of business data to the financial service end for being reviewed by the financial service end to decide whether to lend or not, the amount of the loan or the interest rate. However, with the fast increase of business data and the continuous increase in the number of borrowers, it is difficult for the financial service end to bear the huge amount of business data, resulting in a decrease in the efficiency of loan review and impact on the borrower. Such a problem is described in the following by taking cargo transport as an example.

FIG. 1 is a schematic diagram illustrating the architecture of an exemplary business task (cargo transport task). As shown in FIG. 1, the transport process of one cargo transport task may be provided with multiple task stages (for example, various trade conditions must be met), such as ex works (EXW), free carrier (FCA), free alongside ship (FAS), free on board (FOB), cross-border shipping cost and freight (CFR)/cross-border shipping cost insurance and freight (CIF), carriage paid to CPT)/carriage and insurance paid to (CIP)/delivered duty unpaid (DPU), delivered at place (DAP)/delivered duty paid (DDP), etc. Each stage will generate a large number of logistics documents, such as but not limited to lading bills, delivery orders, warehouse receipts, export declarations, packing orders, packing lists, overseas shipping lading bills, entry customs declarations, shipping fee receipts, storage fees receipts, etc., and each logistics document may also have a large amount of logistics data. Therefore, if using manpower to analyze the logistics data with a huge amount of information, the financial end will definitely consume a lot of manpower and time costs and, further because of the analysis standards being different, the processing efficiency is very low.

In addition, when shipping costs increase, such as in the face of epidemics and wars, the logistics operators who undertake cargo transport tasks often encounter the problem of insufficient working capital due to increased prepaid expenses, so that there is a large demand for borrowing. If the financial end spends a lot of time reviewing the logistics data through manpower, and then decides whether to borrow money or not, the funds will not be immediately available to the logistics operator in need, which may cause the logistics operator to miss the opportunity of the current cargo transport or have an adverse effect to the cargo transport in the future.

Therefore, there is a need for an improved business data processing system, method or computer program product to alleviate and/or obviate the aforementioned problems.

### SUMMARY

The present invention provides a business data processing system performing communication with a user device and a financial end device, which includes: a data organizing subsystem and a data evaluation subsystem. The data organizing subsystem receives at least one document of a business task provided by the user device, and recognizes and organizes the content of the at least one document. The data evaluation subsystem analyzes and verifies the content of the at least one document to generate an overall evaluation information of the business task. The business data processing system transmits the overall evaluation information to the financial end device.

The present invention further provides a business data processing method, which is executed by a business data processing system, wherein the business data processing system includes a data organizing subsystem and a data evaluation subsystem. The business data processing method includes the steps of: using the data organizing subsystem to receive at least one document of a business task provided by a user device, and recognize and organize the content of the at least one document; using the data evaluation subsystem to analyze and verify the content of the at least one document to generate an overall evaluation information of the business task; and using the business data processing system to transmit the overall evaluation information to a financial end device.

The present invention further provides a computer program product stored in a non-transitory computer-readable medium for operating a business data processing system, wherein the business data processing system includes a data processing subsystem and a data evaluation subsystem. The computer program product includes: an instruction for causing the data organizing subsystem to receive at least one document of a business task provided by a user device, and correct and recognize the content of the at least one document; an instruction for causing the data evaluation subsystem to analyze and verify the content of the at least one document so as to generate an overall evaluation information of the business task; and an instruction for causing the business data processing system to transmit the overall evaluation information to a financial end device.

Other objects, advantages, and novel features of the disclosure will become more apparent from the following detailed description when taken in conjunction with the accompanying drawings.

### BRIEF DESCRIPTION OF THE DRAWINGS

FIG. 1 is a schematic diagram illustrating the architecture of an exemplary business task (cargo transport task);

FIG. 2 is a schematic diagram illustrating an application scenario of the business data processing system according to an embodiment of the present invention;

FIG. 3 is a flow chart illustrating the main operation of the business data processing system according to an embodiment of the present invention;

FIG. 4A is a system architecture diagram of the business data processing system according to an embodiment of the present invention;

FIG. 4B is a schematic diagram illustrating a detailed structure of the data processing unit according to an embodiment of the present invention;

FIG. 4C is a schematic diagram illustrating a detailed structure of a verification unit according to an embodiment of the present invention;

FIG. 4D is a schematic diagram illustrating the operation of a score unit according to an embodiment of the present invention;

FIG. 5 is a flow chart illustrating the operation of the data organizing subsystem according to an embodiment of the present invention;

FIG. 6 is a flow chart illustrating the operation of the data evaluation subsystem according to an embodiment of the present invention; and

FIG. 7 is a structural diagram of a financial end device according to an embodiment of the present invention.

### DETAILED DESCRIPTION

The implementation of the present invention is illustrated by specific embodiments to enable persons skilled in the art to easily understand the other advantages and effects of the present invention by referring to the invention contained therein. The present invention is implemented or applied by other different, specific embodiments. Various modifications and changes can be made in accordance with different viewpoints and applications to details disclosed herein without departing from the spirit of the present invention.

It should be noted that, in the specification and claims, unless otherwise specified, having “one” element is not limited to having a single said element, but one or more said elements may be provided.

In addition, in the specification and claims, unless otherwise specified, ordinal numbers, such as “first” and “ second ” , used herein are intended to distinguish components rather than disclose explicitly or implicitly that names of the components bear the wording of the ordinal numbers. The ordinal numbers do not imply what order a component and another component are in terms of space, time or steps of a manufacturing method. A “first” element and a “second” element may appear together in the same component, or separately in different components. The existence of an element with a larger ordinal number does not necessarily mean the existence of another element with a smaller ordinal number.

In addition, the term “adjacent” used herein may refer to describe mutual proximity and does not necessarily mean mutual contact.

In addition, the description of “when . . . ” or “while . . . ” in the present invention means “now, before, or after”, etc., and is not limited to occurrence at the same time. In the present invention, the similar description of “disposed on” or the like refers to the corresponding positional relationship between the two components, and does not limit whether there is contact between the two components, unless specifically limited. Furthermore, when the present invention recites multiple effects, if the word “or” is used between the effects, it means that the effects can exist independently, but it does not exclude that multiple effects can exist at the same time.

In addition, the terms “connect” or “couple” in the specification and claims not only refer to direct connection with another component, but also indirect connection with another component, or refer to electrical connection. Besides, the electrical connection may include a direct connection, an indirect connection, or a mode in which two components communicate through radio signals.

In addition, in the specification and claims, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

In addition, in the present invention, the terms such as “system”, “equipment”, “device”, “module”, or “unit” refer to an electronic component or a digital circuit, an analog circuit or another more generalized circuit composed of a plurality of electronic components, or can be operated by circuits to achieve its function, and unless otherwise specified, they do not necessarily have a rank or hierarchical relationship.

The following description will provide various embodiments of the present invention. It is understood that these examples are not intended to be limiting. The features of the various embodiments of the invention can be modified, substituted, combined, separated and designed to apply to other embodiments.

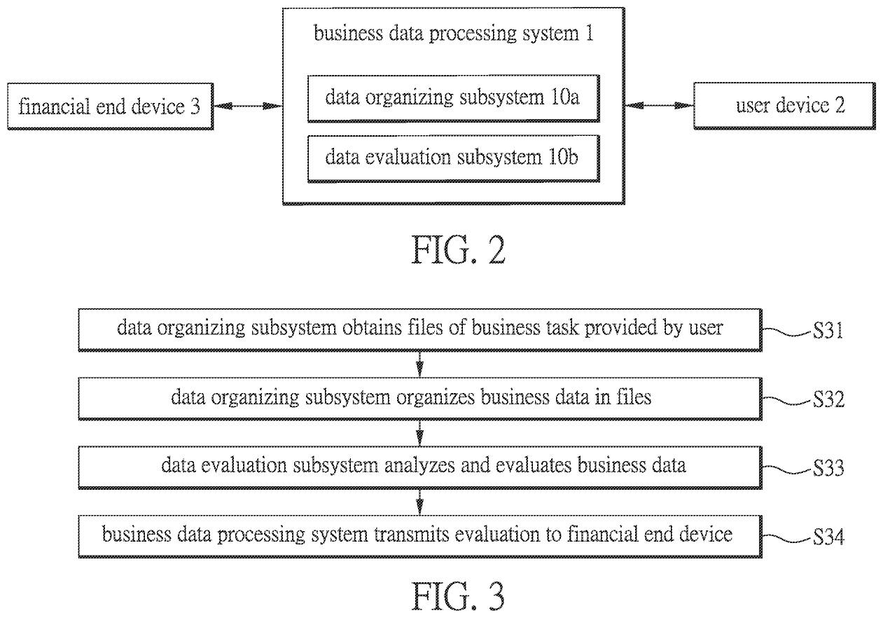

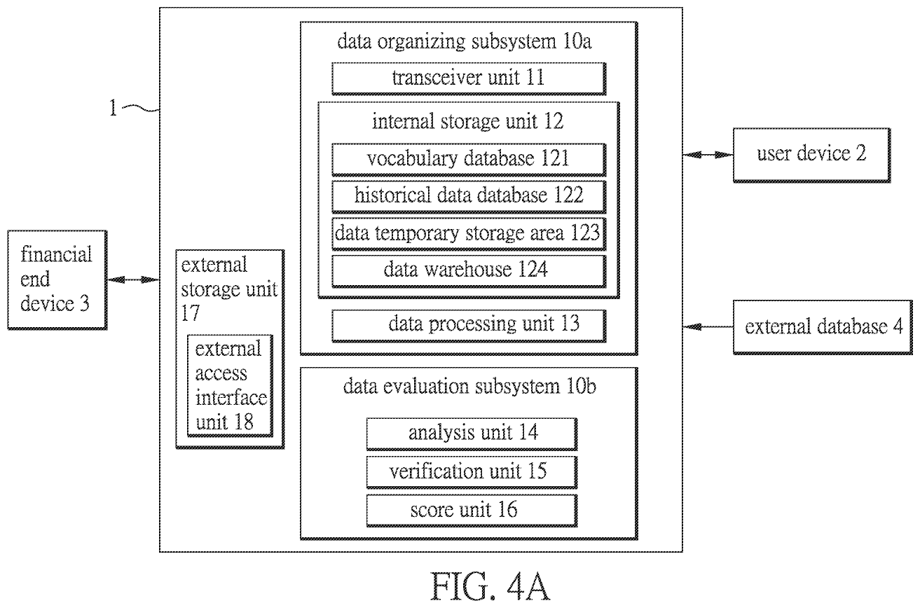

Please refer to FIG. 2 and FIG. 3. FIG. 2 is a schematic diagram illustrating an application scenario of the business data processing system 1 according to an embodiment of the present invention. FIG. 3 is a flow chart illustrating the main steps of the business data processing method executed by the business data processing system 1. As shown in FIG. 2, the business data processing system 1 may perform communication with the user device 2 and the financial end device 3, for example, perform data transmission. In addition, the business data processing system 1 may include a data organizing subsystem 10a and a data evaluation subsystem 10b.

When a user (i.e., a borrower) requests a loan from a financial end for a business task, the user may send a plurality of files related to the business task to the business data processing system 1 through the user device 2. The business data processing system 1 may execute the business data processing method to analyze the business task and give an evaluation, and the financial end device 3 may decide whether to approve the loan according to the evaluation provided by the business data processing system 1. In one embodiment, the business data processing system 1 is, for example, an analysis platform arranged on a network, which may realize its functions through the hardware device of a server, but it is not limited thereto. In addition, in one embodiment, the business data processing system 1, the user device 2 and the financial end device 3 may also be desktop computers, notebook computers, tablet computers, smart phones or other electronic devices with network connection functions, while it is not limited thereto.

The detailed flow of the business data processing method can be referred to FIG. 3. First, step S31 is executed, in which the data organizing subsystem 10a of the business data processing system 1 obtains a plurality of files of the business task provided by the user device 2. Next, step S32 is executed, in which the data organizing subsystem 10a of the business data processing system 1 organizes a plurality of business data in the files. Next, step S33 is executed, in which the data evaluation subsystem 10b of the business data processing system 1 analyzes and evaluates the business data. Next, step S34 is executed, in which the business data processing system 1 transmits the evaluation to the financial end device 3. After that, the financial end device 3 may decide whether to approve the loan according to the evaluation.

It is noted that the business data processing system 1 of the present invention may be applied to loan behaviors in various business models, such as logistics and transport loan, real estate loan, investment loan, etc., but it is not limited thereto. For the convenience of description, the application of the business data processing system in “logistics transport” is taken as an example in the following.

For logistics transport, the “business data processing system 1” may be a logistics data processing system. The “user” may be a logistics operator (i.e., a freight forwarder), which undertakes the seller's goods and is responsible for transporting the seller's goods to the buyer. The “user device 2” may be an electronic device of the user. The “financial end” may be a vender that can provide capital loan services, such as but not limited to banks, lending companies, etc. The “financial end device 3” may be an electronic device used by the financial end. The user's “business task” may be a cargo transport task. The “document(s)” may be one or more logistics documents generated by the cargo transport task. The “business data” may be one or more logistics data in the document.

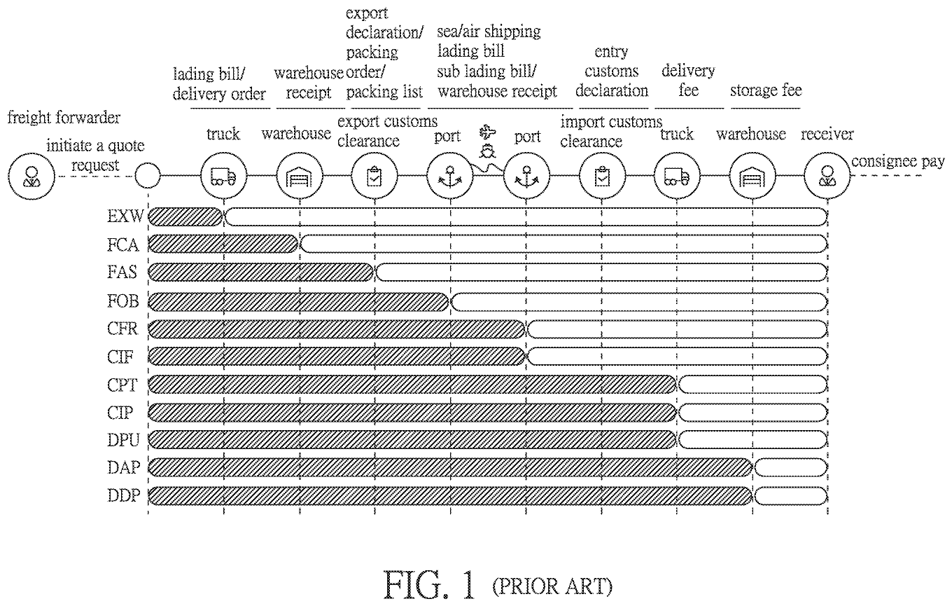

In one embodiment, the types of logistics documents may include dockets, transaction statements, advance payment records or invoice receipts of the current cargo transport task, or various logistics documents listed in FIG. 1, etc., but are not limited thereto. In one embodiment, the types of logistics data may include seller information, buyer information, logistics operator information, information of each transport stage, and information of companies providing services in each transport stage (such as but not limited to airlines, shipping companies, customs of various countries, customs clearance, warehouse and/or truck operators, etc,), or contents of bills, invoices, or transaction proofs, etc., but it is not limited thereto.

In one embodiment, the financial end may have different loan modes and, according to the different loan modes, the user device 2 may provide documents related to the cargo transport task at one time or in batches. For example, the load mode on the financial end may include: “providing all funds at one time before the cargo transport task starts”, “providing all funds at the beginning of the cargo transport task”, or “providing funds required for the stage when various stages of the cargo transport task are completed”, etc., but it is not limited thereto. Furthermore, in the case of “providing all funds at one time before the cargo transport task starts” or “providing all funds at the beginning of the cargo transport task”, the logistics operator may provide all the logistics documents of the current cargo transport task to the business data processing system 1 at one time. In the case of “providing funds required for the stage when various stages of the cargo transport task are completed”, the logistics operator may provide the logistics documents to the business data processing system 1 in batches. In addition, in the case of providing the logistics documents in batches, the evaluation generated by the business data processing system 1 will be continuously adjusted as the logistics documents are updated. However, the present invention is not limited thereto.

In one embodiment, both the data organizing subsystem 10a and the data evaluation subsystem 10b may exist independently outside the business data processing system 1, and may be operated independently. For example, the data organizing subsystem 10a may be used as a single system for processing various data, and the data evaluation subsystem 10b may be used as a single system for evaluating various data, but it is not limited thereto. As a result, the main architecture of the business data processing system 1 may be understood.

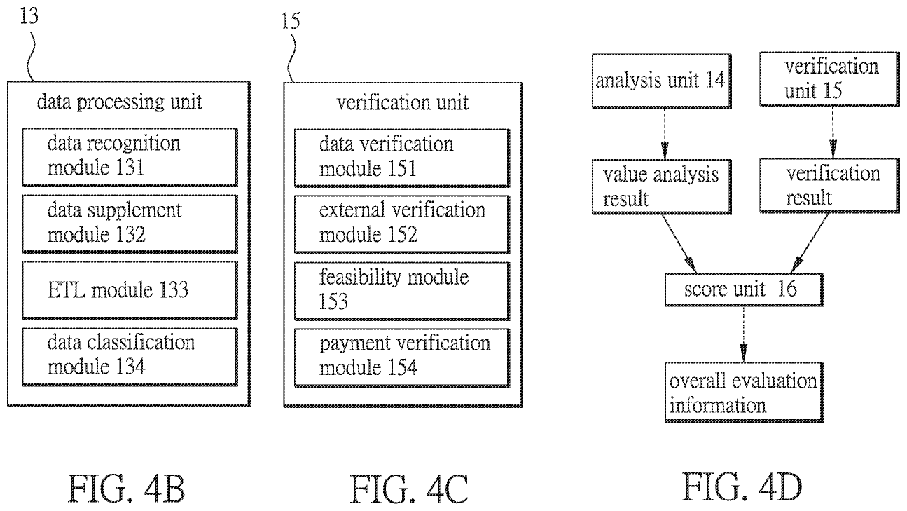

Next, the main architecture of the business data processing system 1 will be described. FIG. 4A is a system architecture diagram of the business data processing system 1 according to an embodiment of the present invention, and please refer to FIG. 4A and FIGS. 1 to 3 at the same time.

As shown in FIG. 4, the business data processing system 1 includes a data organizing subsystem 10a and a data evaluation subsystem 10b. The data organizing subsystem 10a may include a transceiver unit 11, an internal storage unit 12 and a data processing unit 13. The data evaluation subsystem 10b may include an analysis unit 14, a verification unit 15, and a score unit 16. In addition, the business data processing system 1 may also include an external storage unit 17 and an external access interface unit 18.

The transceiver unit 11 of the data organizing subsystem 10a may be used to receive the logistics document transmitted by the user device 2. The data processing unit 13 of the data organizing subsystem 10a may be used to organize the content in the logistics document for being stored in the form of data warehouse, so that the large mount of logistics data of the current cargo transport task can be efficiently classified, and the logistics data and the historical data can be correlated. As a result, the large amount of logistics data generated by the cargo transport task can be efficiently organized, thereby improving the processing efficiency of the business data processing system 1, and saving a lot of time and cost in comparison with the prior art.

The analysis unit 14, the verification unit 15 and the score unit 16 of the data evaluation subsystem 10b may analyze and verify the logistics documents stored in the current cargo transport task, and generate overall evaluation information of the cu rent cargo transport task according to the verification result. In addition, the data evaluation subsystem 10b may store the overall evaluation information of the current cargo transport task in the external storage unit 17, and transmit the evaluation information to the financial end device 3 through the external access interface unit 18. As a result, the business data processing system 1 may automatically generate a reasonable, accurate and trustworthy reference for the financial end to use.

In one embodiment, the data organizing subsystem 10a and the data evaluation subsystem 10b may be provided on a server, and the external storage unit 17 may be provided outside the server (e.g., cloud storage) and connected with the server via a network, but it is not limited thereto. In one embodiment, the business data processing system 1 may include a processor, a memory, and a computer program product disposed on the server. In one embodiment, the processor may execute the computer program product stored in the memory, and cooperate with the memory to realize the functions of the transceiver unit 11, the internal storage unit 12, the data processing unit 13, the analysis unit 14, the verification unit 15, and the score unit 16, but it is not limited thereto.

In one embodiment, the business data processing system 1 may also be connected to an external database 4 to obtain international trade data over the years, wherein the external database may be, for example, but not limited to, the international trade data database provided by government institutions, but it is not limited thereto.

Next, the details of the data organizing subsystem 10a will be described.

First, the “transceiver unit 11” will be described. The transceiver unit 11 may be used for receiving logistics documents provided by the user device 2. In one embodiment, the transceiver unit 11 may be, for example, a user operation interface, a communication interface, an application programming interface (API) or an electronic data interchange (EDI), but it is not limited thereto. In one embodiment, the user device 2 may provide logistics documents in various ways. For example, the data organizing subsystem 10a may be designed to provide a dedicated webpage or mobile application (APP), so that the user device 2 may provide the logistics documents by uploading files, or predetermined text input fields may be provided on webpages or APPs for allowing users to manually input various logistics data for being collected into one or more logistics document files. The aforementioned methods may also be integrated, while it is not limited thereto.

In addition, since a logistics transport task may generate a large number of logistics documents, in order to save the time for subsequent data classification, in one embodiment, the data organizing subsystem 10a may be designed to provide a plurality of predetermined classification options, so that the user device 2 may select the “document type” and/or “transport type” of the logistics document together when providing the document, so as to expedite the processing of subsequent data classification or storage, thereby avoiding a large amount of logistics data from being too divergent and improving the efficiency of subsequent organizing. In one embodiment, the selection of the document type of the logistics document may be, for example, the selection of the logistics document belonging to a lading bill/delivery note, a warehouse receipt, an export declaration/shipping order/packing order, a sea/air/land lading bill/sub-lading bill/manifest, entry declaration or check sheet, etc., while it is not limited thereto. The selection of the transport type of the logistics document may be, for example, selection of sea transport, air transport, rail transport, or truck transport, etc., while it is not limited thereto.

Next, the “internal storage unit 12” will be described. The internal storage unit 12 may include a storage device, such as a memory or a hard disk, but it is not limited thereto. The internal storage unit 12 may be used to store files, data, system event records, logistics vocabulary, programs and schedules between programs, etc., while it is not limited thereto.

In one embodiment, the logistics documents provided to the data organizing subsystem 10a may be a digital text file or an image file. When the file type of a logistics document is a digital text file, the internal storage unit 12 may directly store the logistics document. When the file type of a logistics document is an image file, the data processing unit 13 may convert the image file into a digital text file first, and then the internal storage unit 12 stores the digital text file. However, the present invention is not limited thereto.

In one embodiment, the internal storage unit 12 may have different storage mechanisms, for example, different storage mechanisms may be used for different storage objects. In one embodiment, the storage mechanism of the internal storage unit 12 may include a relational database mechanism, a file-oriented database mechanism or a cache storage mechanism, wherein the internal storage unit 12 may store the content of the logistics document (e.g., logistics data) with the relational database mechanism. Alternatively, the internal storage unit 12 may store the file of the logistics document (e.g., image file or digital text file) with a file-oriented database mechanism, such as Amazon S3 or the like. Alternatively, the internal storage unit 12 may store the programs required for the system operation and the schedules between the programs with the cache storage mechanism. However, the present invention is not limited thereto.

In one embodiment, the internal storage unit 12 may include a vocabulary database 121 for storing a large number of vocabulary, wherein the vocabulary may include logistics terminologies, company names, work item names, work roles, locations, cargo information, etc. involved in past cargo transport tasks, while it is not limited thereto. In one embodiment, the internal storage unit 12 may include a historical data database 122 for storing historical data of past cargo transport tasks, such as the scale, credits or values of various companies of previous cargo transport tasks, or each location passed through in the transport process, name of goods or value of goods, etc., while it is not limited thereto. In addition, the vocabulary database 121 and the historical data database 122 may be pre-established by the administrator of the business data processing system 1, or the business data processing system 1 may automatically obtain data from the external database 4, while it is not limited thereto. The vocabulary database 121 and the historical data database 122 may be updated or modified at any time. In one embodiment, the historical data database 122 may be implemented by means of the data warehouse 124.

In one embodiment, the internal storage unit 12 may also include a data temporary storage area 123 for temporarily storing data or relayed data (e.g., data related to logistics data) being processed by the data organizing subsystem 10a.

Next, the “data processing unit 13” will be described. Please refer to FIGS. 4A and 4B at the same time, wherein FIG. 4B is a schematic diagram illustrating a detailed structure of the data processing unit 13 according to an embodiment of the present invention.

As shown in FIG. 4B, the data processing unit 13 may include a data recognition module 131, a data supplement module 132, an extract-transform-load (ETL) module 133 and a data classification module 134. The data processing unit 13 may recognize, supplement and classify the content of the logistics document to improve the integrity of the content and establish the correlation between the logistics data, thereby improving the efficiency and accuracy of subsequent analysis.

First, the “data recognition module 131” will be described. The data recognition module 131 may be used to recognize the content in the logistics documents. In one embodiment, when the logistics document is an image file, the data recognition module 131 may use optical character recognition (OCR) technology to recognize the text in the image file and convert the same into digital text. In one embodiment, when the logistics document is a digital text file, the data recognition module 131 may use natural language processing (NLP) technology to classify and correspondingly convert the digital text into a format that can be analyzed and verified, thereby recognizing a plurality of vocabulary in digital text. Through the operation of the data recognition module 131, the content of the logistics document may be substantially recognized by the business data processing system 1. The data organizing subsystem 10a thus has substantially obtained the logistics data, such as the name of the buyer, the name of the seller, the content of the goods, the destination, the name of the logistics company, the mode of transport, the name of the shipping/air transport company, etc.

Next, the “data supplement module 132” will be described. Although the data recognition module 131 may roughly recognize the content of the logistics document, some content may be distorted, unrecognizable or missing. In this case, the data supplement module 132 may perform vocabulary correction and data supplement.

Regarding the vocabulary correction, because the dockets are mostly electronic files converted from scanned papers, there is often missing vocabulary or unclear recognition. In one embodiment, the data supplement module 132 recognizes the missing vocabulary through NLP. Alternatively, the unrecognized possible vocabulary is compared with the vocabulary stored in the vocabulary database 121 to determine whether the possible vocabulary recognized by the NLP need to be corrected. In one embodiment, when a recognized possible vocabulary has the same vocabulary in the vocabulary database 121, it means that the possible vocabulary is correct and complete, so that it can be determined that the possible vocabulary does not need to be corrected. Conversely, when the possible vocabulary does not have the same vocabulary in the vocabulary database 121 it means that the possible vocabulary needs to be corrected, or the vocabulary database 121 needs to be updated. For example, when a possible vocabulary is “AAA company”, but there is only “AAB company” in the vocabulary database 121, it means that “AAA company” may be a misspelling of “AAB company” or may be a new vocabulary. The data supplement module 132 may perform the procedure of correcting the vocabulary or updating the vocabulary database 121.

Further, in one embodiment, when a possible vocabulary needs to be corrected, the data supplement module 132 will find a similar vocabulary in the vocabulary database 121, and convert the possible vocabulary into a similar vocabulary, for example, the data supplement module 132 will convert “AAA company” to “AAB company”, thereby completing the correction. In one embodiment, “similar vocabulary” refers to, for example, that two vocabularies have a similarity of more than 50%, 60% or 70%, but it not limited thereto. In one embodiment, after the correction of the data supplement module 132 is completed, the business data processing system 1 may transmit a message to the user device 2 to prompt the user to determine whether the correction result of the data supplement module 132 is correct. If it is correct, the business data processing system 1 is available for the user device 2 to modify the vocabulary.

In addition, in one embodiment, when the data supplement module 132 cannot find similar vocabulary in the vocabulary database or cannot confirm similar vocabulary, the business data processing system 1 may send another message to the user device 2, so as to prompt the user to perform correction by himself/herself. In one embodiment, if the vocabulary corrected by the user is a new vocabulary, the vocabulary database 121 may be automatically updated. As a result, the operation of vocabulary correction can be understood.

Next, the data supplementation will be described. When part of the content of some logistics documents cannot be recognized or some information is missing, the data supplement module 132 may supplement or expand the content of the logistics documents through the historical data of the historical data database 122.

In one embodiment, the data supplement module 132 may execute a label propagation algorithm to use the frequency and/or the location where the recognized vocabulary appears in the current logistics document, and search the features related to the vocabulary. For example, if the vocabulary “AAB company” appears in the current logistics document, but the role of “AAB company” in the current cargo transport task is not recorded, the data supplement module 132 may use the label propagation algorithm to calculate the frequency and/or location where “AAB company” appears in the logistics document of the current cargo transport task, and find similar information in the historical data in the historical data database 122. Furthermore, if “AAB company” in the historical logistics document is usually the seller, the data supplement module 132 may correlate the current vocabulary “AAB company” with the information of the “seller”. By analogy, the content of logistics data can be supplemented.

In one embodiment, the data supplement module 132 may also expand the content of each logistics document through a label propagation algorithm. For example “AAB company” has characteristics such as “good credit” and “high value” in the historical data of the historical data database 122, and the data supplement module 132 may correlate the vocabulary “AAB company” with the characteristics of “good credit” and “high value” through the label propagation algorithm. As a result, the content of the logistics document can be expanded, so that the accuracy of subsequent analysis can be further improved. Accordingly, the operation of data supplementation can be understood.

In addition, in one embodiment, the data supplement module 132 may execute a term frequency-inverse document frequency (TF-IDF) algorithm to calculate the relation between vocabularies in the logistics document, thereby calculating the weight value of each vocabulary in the current logistics document, wherein the weight value may be used by the ETL module 133 to determine the importance of each vocabulary. As a result, the data supplement module 132 can be understood.

Next, the “ETL module 133” will be described. Although, through the operation of the data supplement module 132, the logistics data (such as various vocabularies) of the current cargo transport task has been supplemented, corrected or expanded, but the logistics data is still in an unorganized state and may be scattered in different storage areas of the data storage unit 12. In addition, the content in the logistics document may also contain unnecessary content, and excessive information will also cause the burden in the subsequent analysis. The ETL module 133 may process the logistics data of the current cargo transport task, so that the logistics data can be subsequently stored in the historical data database 122 (data warehouse 124).

The ETL module 133 may extract the logistics data of the current cargo transport task from the data storage unit 12, and then convert the logistics data and related data into block data suitable for the historical data database 122 (data warehouse 124) for being stored in the historical data database 122 (data warehouse 124).

In one embodiment, the conversion process performed by the ETL module 133 includes removing less important logistics data or uncorrectable logistics data for facilitating subsequent analysis. In one embodiment, based on the weight value of each logistics data calculated by the data supplement module 132 that executes the TF-IDF algorithm, the ETL module 133 may clear the logistics data with a weight value smaller than a predetermined threshold value the importance value is low).

In one embodiment, the ETL module 133 may execute a zipper algorithm to retain and clear the logistics data. In one embodiment, the technology used in the zipper algorithm may include del/ins, upsert, append, standard zipper (full history zipper), incremental zipper, addition and deletion zipper, full addition and deletion zipper and/or self-zipper, but it is not limited thereto.

Next, the “data classification module 134” will be described. The data classification module 134 classifies the logistics data to be stored in the historical data database 122 (data warehouse 124) and the historical data in the data warehouse 124, so as to determine the storage method and location of the logistics data.

In one embodiment, the data classification module 134 may perform classification by means of machine learning, for example, by means of decision tree, SVM, K-Means or CNN. With the data classification module 134, the important logistics data of the current logistics document will be correlated with the historical data in the data warehouse 124 and stored in the historical data database 122 (data warehouse 124). As a result, the huge information generated by one cargo transport task may be sorted into the data warehouse 124 and may be used by the business data processing system 1.

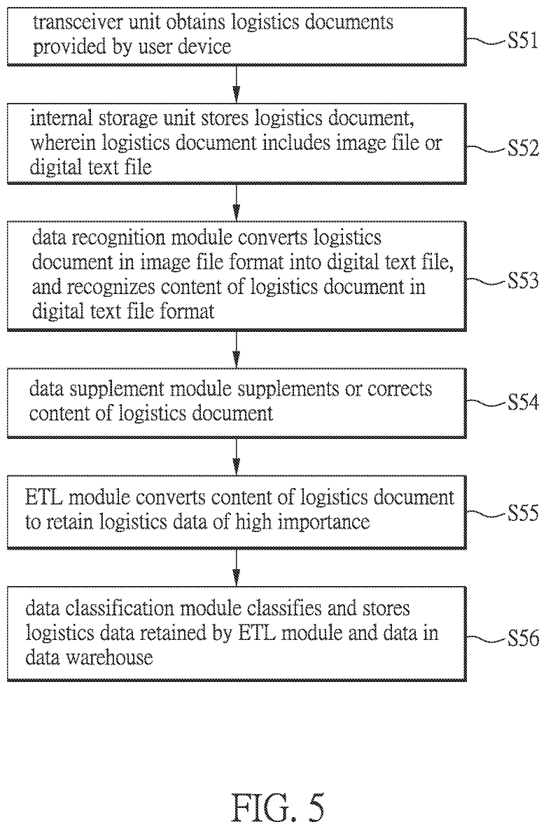

Next, the main operation flow of the data organizing subsystem 10a will be described. FIG. 5 is a flow chart illustrating the steps of a data organizing method according to an embodiment of the present invention, and please refer to FIGS. 4A and 4B at the same time.

As shown in FIG. 5, step S51 is first executed, in which the transceiver unit 11 obtains a large number of logistics documents provided by the user device 2. Next, step S52 is executed, in which the internal storage unit 12 stores the logistics document, wherein the logistics document may include an image file or a digital text file. Next, step S53 is executed, in which the data recognition module 131 converts the logistics document in the image file format into a digital text file, and recognizes the content of the logistics document in the digital text file format. Next, step S54 is executed, in which the data supplement module 132 supplements or corrects the content of the logistics document. Next, step S55 is executed, in which the ETI, module 133 converts the content of the logistics document to retain the logistics data of high importance. Next, step S56 is executed, in which the data classification module 134 classifies and stores the logistics data retained by the ETL module 133 and the historical data in the historical data database 122 (data warehouse 124). As a result, the data organizing subsystem 10a may efficiently classify and store a large amount of logistics data, and may correlate the same with historical data, so as to improve the speed and accuracy of the subsequent analysis.

Next, the details of the data evaluation subsystem 10b will be described, and please refer to FIG. 4A again.

Through the operation of the data organizing subsystem 10a, the data content of the current cargo transport task may be recognized, and the important logistics data has been stored in the historical data database 122 (data warehouse 124) and is available for the evaluation subsystem 10b, so that the data evaluation subsystem 10b may be aware of various information of the current cargo transport task, such as the role of each company, freight, cargo content, etc., and may analyze various information, so as to generate the overall evaluation of the current cargo transport task according to the analysis results.

First, the “analysis unit 14” will be described. The analysis unit 14 may analyze the values of multiple companies (such as but not limited to buyers, sellers, contractors, manufacturers of goods and/or shipping companies, etc.) involved in the current cargo transport task according to historical records, and generate a value analysis result (e.g., an evaluation) of the current cargo transport task, wherein the “historical record” may include historical data stored in the data warehouse 124 and international trade data obtained from the external database 4, while it is not limited thereto.

The following description is given by taking “company A submits a cargo transport task, and company A is responsible for helping company B to transport the goods to company C”.

In one embodiment, the past transaction records of the company may be used as a basis for value analysis. For example, if the historical records show that company B has many transaction records in the past, the analysis unit 14 will give a high evaluation to the current cargo transport task based on the performance of company B in this part and, if the historical records show that company C never has any transaction record, the analysis unit 14 will give a lower evaluation to the current cargo transport task for the performance of C company in this part, while it is not limited thereto. In addition, in one embodiment, the size of the company may also be used as an analysis basis. For example, if the historical records show that the scales of companies B and C are both large, the analysis unit 14 will give a higher evaluation to the current cargo transport task for the companies B and C this part and, vice versa, give a lower evaluation. After all the analysis bases have been evaluated, the analysis unit 14 may integrate the evaluations of the analysis bases, such as taking an average value or performing a weighted calculation, so as to generate the value analysis result of the current cargo transport task.

It is noted that, in addition to the past transaction records and scale of the company, the present invention may be provided with more analysis basis, such as the past loan records, past reimbursement records or credit information of the company, while it is not limited thereto.

Next, the “verification unit 15” will be described. Please refer to FIGS. 4A and 4C at the same time, wherein FIG. 4C is a schematic diagram illustrating a detailed structure of the verification unit 15 according to an embodiment of the present invention.

As shown in FIG. 4C, the verification unit 15 may include a data verification module 151, an external verification module 152, a feasibility module 153 and a payment verification module 154. The verification unit 15 may mainly perform verification and feasibility analysis on the content of the logistics document (such as logistics data) of the current cargo transport task, for example, performing analysis and verification, according to the rationality and integrity of the content, whether the transport task really exists, etc., so as to generate a verification result of the current cargo transport task. The verification result may include a review item review result, an external verification analysis result or a feasibility analysis result.

First, the “data review module 151” will be described. The data review module 151 may review the integrity of the logistics document according to the relevant specifications of the type of the logistics document. For example, when the logistics document is a sea lading bill, the data, review module 151 may review the integrity of the data of the logistics document according to the relevant specifications of the sea lading bill. In one embodiment, the business data processing system 1 may store relevant specifications of various types of logistics documents, such as, but not limited to, the relevant specifications for which data content must be present.

To explain in more detail, in one embodiment, the system 1 may pre-store a review list corresponding to each type of logistics document, wherein each review list includes a plurality of necessary review items, such as a lading bill type logistics document may correspond to some review items, etc. The data review module 151 may review whether the aforementioned examples record various review items corresponding to the logistics document and record the review results of the various review items, thereby forming the data integrity analysis result of the current cargo transport task. In one embodiment, when the data review module 151 finds that the logistics document lacks review items, the user may also be requested to supplement, for example, sending a reminder message to request the user to supplement the data within a certain period while it is not limited thereto. In addition, in one embodiment, the data review module 151 may also analyze whether the values and/or data in the logistics document a e reasonable. In addition, the data review module 151 may record the review results of various review items in the logistics document, and then generate the data review, and analysis results of the current cargo transport task for being transmitted to the score unit 16.

Next, the “external verification module 152” will be described. The external verification module 152 may generate an external verification analysis result of the current cargo transport task according to external verification information of the logistics document of the current cargo transport task. In one embodiment, the external verification information may include “whether the logistics documents of the current cargo transport task have been verified by a third-party verification unit, such as whether the logistics documents of receipt and invoice type have been verified by an accountant, whether the logistics documents of the lading bill type have been verified by the transport company, what is the identity of the third-party verification unit, the evaluation of the third-party verification unit and/or the verification results of the third-party verification unit, etc., while it is not limited thereto. The external verification module 152 may integrate and record the analysis results of various external verification information, and then generate the external verification analysis results of the current cargo transport task. Furthermore, the external verification module 152 may transmit the external verification analysis result of the current cargo transport task to the score unit 16.

In one embodiment, the third-party verification unit may be, for example, an accounting firm, a custom or a transportation company, while it is not limited thereto.

In one embodiment the operation of the external verification module 152 may be an optional item, that is, the system administrator may disable the operation of the external verification module 152, or the data evaluation subsystem 10b may not have the external verification module 152.

Next, the “feasibility module 153” will be described. The feasibility module 153 may analyze the feasibility of the current cargo transport task and, specifically, analyze whether the current cargo transport task is reasonable according to historical records, such as whether the purchasing goods are commodities that can be purchased by the buyer and the seller, the unit price of the purchase, and whether the transaction location has historical records for corroboration, etc., while it is not limited thereto.

In one embodiment, the feasibility module 153 may review whether the content of the logistics document is reasonable according to the historical records (the historical data stored in the data warehouse 124 and the international trade data obtained from the external database 4), and the review items may include: the identity of the seller, the identity of the buyer, the content of the goods, the value of the goods and/or the mode of transport, etc., while it is not limited thereto. Taking the above example for illustration, information including “whether company B acts as a seller”, “whether company C bought goods from company B”, “whether the main goods of company B are fruits”, “how much is the usual value of the goods of company B” will be reviewed. If the currently reviewed item is consistent with the historical record, such as but not limited to a similarity of more than 70%, the feasibility module 153 will evaluate this item as a high evaluation, otherwise, as a low evaluation.

In one embodiment, the feasibility module 153 may also verify whether the content of the logistics document is authentic according to the international trade data of the external database 4. For example, the logistics document records the information “the goods of company B are being transported by air”, and the international trade data of the external database 4 also records that, when the goods of company B are being transported by air, the feasibility module 153 will evaluate this part as feasible.

Furthermore, the feasibility module 153 may record the feasibility analysis result of the content of each logistics document, and then generate and transmit the same to the score unit 16.

In addition, in one embodiment, when the feasibility module 153 finds that there is doubt about the feasibility of a certain logistics data, for example, the price of the goods displayed in other documents of the current cargo transport task is twenty thousands, but the invoice docket shows that the price of the goods is one million, the feasibility module 153 may give the logistics data on the invoice to the data review module 151 for re-review to determine the rationality. When the data review module 151 determines that the data is unreasonable according to the historical information, the data review module 151 may send a reminder message to request the user to make corrections within a time limit.

Next, the payment verification module 154 will be described. The payment verification module 154 may adjust the evaluation method of the score unit 16 according to the payment results after the completion of each stage of the current cargo transport task, such as adjusting the weight values of various parameters, wherein the parameters may be, for example, value analysis results, data review analysis results, external validation analysis results and feasibility analysis results. In one embodiment, the adjustment of the weight value may be performed automatically through a predetermined algorithm, but it is not limited thereto.

In one embodiment, the evaluation basis of the payment verification module 154 may include the completion rate of the cargo transport task, the delay time for the user to receive the payment from the entrusting party, the difference between the amount advanced by the user and the amount of the payment actually received and whether the difference is within the predetermined allowable range, the delay time and error rate at each stage of the cargo transport task, etc., while it is not limited thereto.

In one embodiment, the operation of the payment verification module 154 may be an optional matter, that is, the system administrator may disable the operation of the payment verification module 154, or the data evaluation subsystem 10b may not have the payment verification module 154. As a result, the payment verification module 154 can be understood.

Next, the “score unit 16” will be described, and please refer to FIG. 4D, which is a schematic diagram illustrating the operation of the score unit 16 according to an embodiment of the present invention.

The score unit 16 may perform a weighted calculation on the value analysis results generated by the analysis unit 14 and the verification results generated by the verification unit 15 (at least including the data review analysis results of the data review module 151 and the feasibility analysis results of the feasibility module 153) so as to generate the overall evaluation information of the current cargo transport task. In one embodiment, the overall evaluation information may be, for example, an index, a score, or various information that can display the evaluation. In one embodiment, when the overall evaluation information is an index, different types of cargo transport tasks may correspond to different indices, for example, the index of one cargo transport task may be 110, and the index of another cargo transport task may be 1000, while it is not limited thereto.

Since the score unit 16 generates the overall evaluation information not only by using historical records to analyze the value of the current cargo transport task, but also by using various verification mechanisms to verify the feasibility of the cargo transport task, the overall evaluation information may accurately reflect the risks and rewards of the current cargo transport task, which can be used as a reference for the financial end to decide whether to agree the loan. For example, although a certain cargo transport task provides less data and thus has a lower feasibility evaluation and data integrity evaluation, because the companies involved in the cargo transport task are all large-scale companies, the cargo transport task may still has a high value evaluation thereby also reducing the risk of evaluation errors. As a result, the present invention may provide a more accurate evaluation.

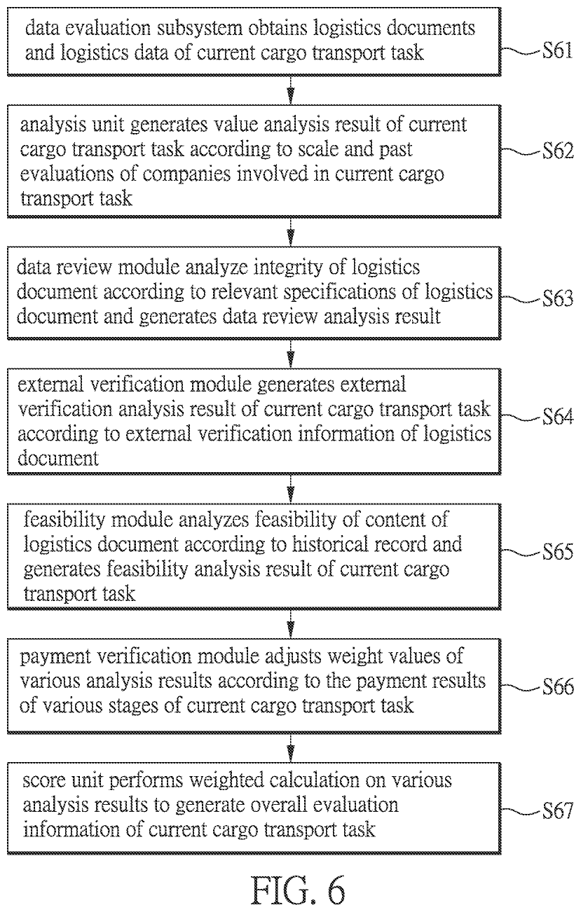

Next, the operation flow of the data evaluation subsystem 10b will be described. FIG. 6 is a flow chart illustrating the steps of a data evaluation method according to an embodiment of the present invention, and please refer to FIG. 6 and FIGS. 4A and 4C at the same time.

As shown in FIG. 6, step S61 is first executed, in which the data evaluation subsystem 10b obtains the logistics documents and logistics data of the current cargo transport task. Next, step S62 is executed, in which the analysis unit 14 of the data evaluation subsystem 10b generates a value analysis result of the current cargo transport task according to the scale and past evaluations of the companies involved in the current cargo transport task. In addition, step S63 is executed, in which the verification unit 15 of the data evaluation subsystem 10b verifies the data integrity of the logistics document according to the relevant specifications of the logistics document, so as to generate the data review and analysis result of the current cargo transport task. Next, step S64 is executed, in which the verification unit 15 generates the external verification analysis result of the cargo transport task according to the external verification information of the logistics document. Next, step S65 is executed, in which the verification unit 15 analyzes the feasibility of the current cargo transport task according to the historical records, and generates a feasibility analysis result. Next, step S66 is executed, in which the verification unit 15 adjusts the weight values of various analysis results according to the payment collection situation at each stage of the current cargo transport task. Next, step S67 is executed, in which the score unit 16 performs weighted calculation on the value analysis result generated by the analysis unit 14 and the verification result generated by the verification unit 15 so as to generate the overall evaluation information of the current cargo transport task.

It is noted that, in some embodiments, step S64 and/or step S66 may not be executed.

In one embodiment, the data of the logistics document obtained by the data evaluation subsystem 10b in step S51 may be from the data warehouse 124 of the data organizing subsystem 10a, but may also be input from the outside without going through the data organizing subsystem 10a. In addition, in one embodiment, the operation of the analysis module 14 and the operation of the verification unit 15 may be performed simultaneously, but it is not limited thereto. As a result, the operation process of the data evaluation subsystem 10b can be understood.

With reference to FIG. 3 and FIG. 4A again, the details of the external storage unit 17 and the external access interface unit 18 will be described.

After the data evaluation subsystem 10b generates the overall evaluation information of the current cargo transport task, the data evaluation subsystem 10b may transmit the overall evaluation information to the external storage unit 17 for storage, and use the external access interface unit 18 to store the overall evaluation information. The overall evaluation information is transmitted to the financial end device 3.

In one embodiment, in addition to the overall evaluation information, the external storage unit 17 may also store more data, such as backing up the data stored in the internal storage unit 12, backing up the data generated when the data processing unit 13 operates and the historical data in the data warehouse 124, or storing all the evaluation results of the analysis unit 14, the verification unit 15, and the score unit 16, etc., while it is not limited thereto.

In one embodiment, the external storage unit 17 may store data in the manner of a block-chain, a relational database and/or a file-oriented database, while it is not limited thereto.

In one embodiment, the external access interface unit 18 may be an operation interface, API or EDI of the external storage unit 17, which may transmit the information of the overall evaluation of the current cargo transport task to the financial end device 3 according to the instructions of the business data processing system 1. In addition, in one embodiment, the digital text file of the logistics document of the current cargo transport task may also be transmitted to the financial end device 3 through the external access interface unit 18. As a result, the external storage unit 17 and the external access interface unit 18 can be understood.

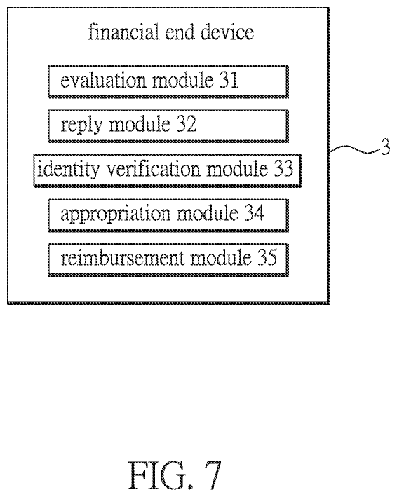

Next, the operation of the financial end device 3 will be described. FIG. 7 is a schematic diagram illustrating the financial end device 3 according to an embodiment of the present invention, and please refer to FIGS. 2 to 6 at the same time.

As shown in FIG. 7, the financial end device 3 may include an evaluation module 31, a reply module 32, a identity verification module 33, an drawdown module 34 and a repayment module 35.

Regarding the evaluation module 31, in one embodiment, when the financial end device 3 receives the overall evaluation information of the current cargo transport, the evaluation module 31 may determine whether to provide a loan according to the overall evaluation information, which can be realized by a predetermined algorithm. In addition, in one embodiment, when the financial end device 3 receives the documents related to the current cargo transport, for example, when receiving the digital text file of the logistics document, the evaluation module 31 may automatically determine whether the current cargo transport task still requires for the logistics documents to be added or referred to. If the logistics documents to be added or referred to are not required, the identity verification module 33 may start to operate and, if the logistics documents to be added or referred to are required, the reply module 32 may start to operate, which can also be achieved through a predetermined algorithm.

Regarding the reply module 32, in one embodiment, the reply module 32 may transmit a message to the user device 2 through the business data processing system 1 to remind the borrower of additional logistics documents that must be provided, or to request the borrower to provide relevant historical data or evidence from other external verification units, or to request the borrower to supplement the integrity of certain logistics documents. In one embodiment the reply module 32 may be configured with a supplementary period so that, for example, when the logistics operator has not supplemented the required logistics documents when the supplementary period expires, the reply module 32 may stop the financial end device 3 from responding to the operation of the current cargo transport.

Regarding the identity verification module 33, in one embodiment, the identity verification module 33 may transmit information such as the loanable ratio and interest rate of the cargo transport task to the user device 2. If the user device 2 transmits back an agreement message to the financial end device 3, the security of the current cargo transport task may be completed. Conversely, if the identity verification module 33 does not receive the message returned by the user device 2 or receives a message of disagreement, the identity verification module 33 may suspend the operation of the financial end device 3, and the staff of the financial end may directly negotiate with the user. In one embodiment, the identity verification module 33 may use an algorithm to automatically generate the loanable ratio and interest rate according to the overall evaluation score of the current cargo transport task. However, in another embodiment, the loanable ratio and interest rate may be manually input to the financial end device 3.

Regarding the drawdown module 34, in one embodiment after the ensuring is completed, the drawdown module 34 may automatically allocate funds to the borrower at appropriate timing, for example, automatically transfer funds to a financial account designated by the borrower at an appropriate time by means of digital transfer. The “appropriate timing” may be, for example, providing funds immediately, providing funds on a specified date before the shipment of goods, or providing funds when receipts for various stages of the task of shipping goods are received, etc., while it is not limited thereto.

Regarding the repayment module 35, in one embodiment, the repayment module 35 may determine whether to perform settlement according to whether the user has repaid or not, so as to end the loan process, while it is not limited thereto.

With the cooperation of the business data processing system 1, the user device 2 and the financial end device 3, the time efficiency can be improved and the labor cost can be reduced.

Accordingly, the business data processing system 1 of the present invention may automatically analyze the cargo transport task submitted by the borrower, and automatically complete the loan behavior through the cooperation with the user device 2 and the financial end device 3. Alternatively, the data organizing subsystem 10a of the present invention may automatically supplement, correct and organize all data contents of the current cargo transport task, and may improve the integrity and correctness of the data, thereby improving the efficiency and effectiveness of the subsequent analysis. Alternatively, the business data analysis and verification subsystem 10b of the present invention may automatically analyze the data content of the cargo transport task, and give an evaluation according to the value, rationality and integrity of the current cargo transport task for reference by the financial end. Accordingly, the present invention can save a lot of time and cost and improve the security of loan disbursement.

In addition, the features of the various embodiments of the present invention may be arbitrarily mixed and matched as long as they do not violate the spirit of the invention or conflict with each other.

The aforementioned embodiments are examples only for convenience of description. The scope of the present disclosure is claimed hereinafter in the claims and is not limited to the embodiments.

What is claimed is:

1. A business data processing system performing communication with a user device and a financial end device, comprising:
a data organizing subsystem for receiving at least one document of a business task provided by the user device, and recognizing and organizing content of the at least one document; and
a data evaluation subsystem for analyzing and verifying the content of the at least one document after being recognized and organized, so as to generate an overall evaluation information of the business task,
wherein the business data processing system transmits the overall evaluation information to the financial end device.

2. The business data processing system of claim 1, wherein the business task is a cargo transport task, the at least one document is at least one logistics document, and a type of the at least one logistics document includes: a docket, a report, a reimbursed expenses record, or an invoice receipt of the cargo transport task.

3. The business data processing system of claim 1, wherein a file type of the at least one logistics document includes an image file or a digital text file, in which the data organizing subsystem uses optical character recognition technology (OCR) to convert the image file into a digital text file and uses a natural language processing (NLP) technology to recognize a plurality of vocabularies from the digital text file.

4. The business data processing system of claim 3, wherein the data organizing subsystem corrects the organized vocabulary according to a vocabulary database.

5. The business data processing system of claim 4, wherein the data organizing subsystem executes a label propagation algorithm to correlate the recognized vocabulary with vocabulary in a historical record for being stored in a data warehouse.

6. The business data processing system of claim 5, wherein the correlated vocabulary is related to at least one company, and the data evaluation subsystem generates a value analysis result of the cargo transport task according to the value of at least one company related to the transport task in the correlated vocabulary, and analyzes data integrity of the at least one logistics document according to specifications related to type of the at least one logistics document thereby generating a data review analysis result of the cargo transport task.

7. The business data processing system of claim 6, wherein the data evaluation subsystem further generates an external verification result of the cargo transport task according to an external verification information.

8. The business data processing system according to claim 7, wherein the data evaluation subsystem further analyzes the at least one logistics document based on historical data in the data warehouse and/or international trade data in an external database to generate a feasibility analysis result of the cargo transport task, and generates the overall evaluation information according to the value analysis result, the data review analysis result, the external verification result and the feasibility analysis result.

9. A business data processing method executed by a business data processing system performing communication with a user device and a financial end device and including a data organizing subsystem and a data evaluation subsystem, the method comprising the steps of:
using the data organizing subsystem to receive at least one document of a business task provided by the user device, and recognize and organize content of the at least one document; and
using the data evaluation subsystem to analyze and verify the content of the at least one document after being recognized and organized, so as to generate an overall evaluation information of the business task; and
using the business data processing system to transmit the overall evaluation information to the financial end device.

10. A computer program product stored in a non-transitory computer-readable medium for operating a business data processing system performing communication with a user device and a financial end device and including a data organizing subsystem and a data evaluation subsystem, the computer program product comprising:
an instruction for causing the data organizing subsystem to receive at least one document of a business task provided by the user device, and recognize and organize content of the at least one document; and
an instruction for causing the data evaluation subsystem to analyze and verify the content of the at least one document after being recognized and organized, so as to generate an overall evaluation information of the business task; and
an instruction for causing the business data processing system to transmit the overall evaluation information to the financial end device. 5
